(19) United States
(12) Patent Application Publication
(10) Pub. No.: US 2008/0086309 A1
(43) Pub. Date: Apr. 10, 2008

(54) Method for operating a hearing aid, and hearing aid

(75) Inventors: Eghart Fischer, Schwabach (DE); Matthias Frohlich, Eriangen (DE); Jens Hain, Kleinsendelbach (DE); Henning Puder, Erlangen (DE); Andre Steinbubeta, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/973,441

(22) Filed: Oct. 9, 2007

(30) Foreign Application Priority Data
Oct. 10, 2006 (DE) 102006047963.7 DE

(51) Int. Cl. G10L 21/02

(52) U.S. Cl. 704/271

(57) ABSTRACT

A “speech” operating mode is established by a signal processor of a hearing aid for tracking and selecting an acoustic speech source in an ambient sound. The electric acoustic signals are generated by the hearing aid from the ambient sound that has been picked up, from which signals an electric speech signal very probably containing speech is identified and selected by the signal-processor, and the electric speech signal is selectively taken into account in an output sound of the hearing aid in such a way that it will for the hearing-aid wearer acoustically at least be prominent compared with another acoustic source and consequently be better perceived by the hearing-aid wearer.

### CROSS REFERENCE TO RELATED APPLICATIONS

This application claims priority of German application No. 102006047963.7 DE filed Oct. 10, 2006, which is incorporated by reference herein in its entirety.

### FIELD OF INVENTION

The invention relates to a method for operating a hearing aid consisting of a single hearing device or two. The invention relates further to a corresponding hearing aid or hearing device.

### BACKGROUND OF INVENTION

When we listen to someone or something, interference noise or undesired acoustic signals are everywhere present that interfere with the voice of someone opposite us or with a desired acoustic signal. People with a hearing impairment are especially susceptible to such interference noise. Background conversations, acoustic disturbance from digital devices (cell phones), or noise from automobiles or other ambient sources can make it very difficult for a hearing-impaired person to understand a wanted speaker. A reduction of the noise level in an acoustic signal coupled with an automatic focusing on a desired acoustic-signal component can significantly improve the efficiency of an electronic speech processor of the type used in modern hearing aids.

Hearing aids have very recently been introduced that employ digital signal processing. They contain one or more microphones, A/D converters, digital signal processors, and loudspeakers. The digital signal processors usually divide the incoming signals into a plurality of frequency bands. An amplification and processing of signals can be individually adjusted within each band in keeping with requirements for a specific wearer of the hearing aid in order to improve a specific component's intelligibility. Further available in connection with digital signal processing are algorithms for minimizing feedback and interference noise, although they have significant disadvantages. What is disadvantageous about the currently employed algorithms for minimizing interference noise is, for example, the maximum improvement they can achieve in hearing-aid acoustics when speech and background noise are located within the same frequency region, which renders them incapable of distinguishing between spoken language and background noise. (See also EP 1 017 253 A2)

That is one of the most frequently occurring problems in acoustic signal processing, namely filtering out one or more acoustic signals from among different such signals that overlap. The problem is referred to also as what is termed the “cocktail party problem”. All manner of different sounds including music and conversations therein merge into an indefinable acoustic backdrop. People nevertheless generally do not find it difficult to hold a conversation in such a situation. It is therefore desirable for hearing-aid wearers to be able to converse in just such situations like people without a hearing impairment.

Within acoustic signal processing there exist spatial (directional microphone, beam forming, for instance), statistical (blind source separation, for instance), and hybrid methods which, by means of algorithms and otherwise, are able to separate out one or more sound sources from among a plurality of simultaneously active such sources. Thus by means of statistical signal processing performed on at least two microphone signals, blind source separation enables source signals to be separated without prior knowledge of their geometric arrangement. When applied to hearing aids, that method has advantages over conventional approaches based on a directional microphone. With said type of BSS (Blind Source Separation) method it is inherently possible with n microphones to separate up to n sources, meaning to generate n output signals.

Known from the relevant literature are blind source separation methods wherein sound sources are analyzed by analyzing at least two microphone signals. A method of said type and a corresponding device therefore are known from EP 1 017 253 A2, the scope of whose disclosure is expressly to be included in the present specification. Relevant links from the invention to EP 1 017 253 A2 are indicated chiefly at the end of the present specification.

In a specific application for blind source separation in hearing aids, that requires two hearing devices to communicate (analyzing of at least two microphone signals (right/left)) and both hearing devices' signals to be evaluated preferably binaurally, which is performed preferably wirelessly. Alternative couplings of the two hearing devices are also possible in an application of said type. A binaural evaluating of said kind with a provisioning of stereo signals for a hearing-aid wearer is disclosed in EP 1 655 998 A2, the scope of whose disclosure is likewise to be included in the present specification. Relevant links from the invention to EP 1 655 998 A2 are indicated at the end of the present specification.

The controlling of directional microphones for performing a blind source separation is subject to equivocality once a plurality of competing useful sources, for example speakers, are presented simultaneously. While blind source separation basically allows the different sources to be separated, provided they are spatially separate, the potential benefit of a directional microphone is reduced by said equivocality, although a directional microphone can be of great benefit in improving speech intelligibility specifically in such scenarios.

### SUMMARY OF INVENTION

The hearing aid or, as the case may be, the mathematical algorithms for blind source separation is/are basically faced with the dilemma of having to decide which of the signals produced through blind source separation can be forwarded to the algorithm user, meaning the hearing-aid wearer, to greatest advantage. That is basically an insoluble problem for the hearing aid because the choice of desired acoustic source will depend directly on the hearing-aid wearer's momentary will and hence cannot be available to a selection algorithm as an input variable. The choice made by said algorithm must accordingly be based on assumptions about the listener's likely will.

The prior art proceeds from the hearing-aid wearer's preferring an acoustic signal from a 0° direction, meaning from the direction in which he/she is looking. That is realistic insofar as the hearing-aid wearer would in an acoustically difficult situation look toward his/her current conversation partner in order to obtain further cues (for example lip movements) for enhancing said partner's speech intelligibility. The hearing-aid wearer will, though, consequently be compelled to look at his/her conversation partner so that the directional microphone will produce an enhanced speech intelligibility. That is annoying particularly when the hearing-aid wearer wishes to converse with precisely one person, which is to say is not involved in communicating with a plurality of speakers, and does not always wish/have to look at his/her conversation partner.

Furthermore, there is to date no known technical method for making a “correct” choice of acoustic source or, as the case may be, one preferred by the hearing-aid wearer, after source separating has taken place.

On the assumption that spoken language is of more interest to hearing-aid wearers than non-verbal acoustic signals, a more flexible acoustic-signal selection method can be formulated that is not limited by a geometric acoustic-source arrangement. An object of the invention is therefore to disclose an improved method for operating a hearing aid, and an improved hearing aid. Which of the electric output signals resulting from a source separation, in particular a blind source separation, is acoustically routed to the hearing-aid wearer is especially an object of the invention. It is hence an object of the invention to discover which is very probably a preferred acoustic speech source for the hearing-aid wearer.

The invention therein provides for performing a feature analysis of separated acoustic signals, once a source separation has taken place, with the aim of the hearing aid's selecting the acoustic source or sources very probably containing spoken language as the acoustic speech source or sources that will be offered to the hearing-aid wearer. The hearing-aid wearer can then decide whether he/she wants said source or sources or not, which can be indicated by means of any input device or a voice-recognition means in or on the hearing aid or a remote control for the hearing aid. It can also be done in an automated manner by the hearing aid (see below).

A method for operating a hearing aid is inventively provided wherein for tracking and selectively amplifying an acoustic speech source or electric speech signal a signal-processing means of the hearing aid determines and assigns preferably for all electric acoustic signals available to it a probability that they contain spoken language. The acoustic source or sources most probably containing speech will be tracked by the signal-processing means and taken particularly into account in an acoustic output signal of the hearing aid.

Further inventively provided is a hearing aid wherein electric acoustic signals can be allocated a respective probability of containing spoken language by an acoustic module (signal-processing means) of the hearing aid. The acoustic module selects therefrom at least one electric speech signal that can be taken particularly into account in an output sound of the hearing aid.

It is inventively possible, depending on the number of microphones in the hearing aid, to select one or more acoustic speech sources within the ambient sound and emphasize it/them in the hearing aid's output sound. It is possible therein to flexibly adjust a volume of the acoustic speech source or sources in the hearing aid's output sound.

In a preferred exemplary embodiment of the invention the signal-processing means has an unmixer module that operates preferably as a device for blind source separation for separating the acoustic sources within the ambient sound. The signal-processing means further has a post-processor module which, when an acoustic source very probably containing speech has been detected, will set up a corresponding “speech” operating mode in the hearing aid. The signal-processing means can further have a pre-processor module—whose electric output signals are the unmixer module's electric input signals—which standardizes and conditions electric acoustic signals originating from microphones of the hearing aid. As regards the pre-processor module and unmixer module, reference is made to EP 1 017 253 A2 paragraphs [0008] to [0023].

In a preferred exemplary embodiment of the invention the hearing aid or signal-processing means or post-processor module performs a feature analysis of the electric acoustic signals to the effect that for each of the electric acoustic signals a probability that it contains spoken language information is determined simultaneously and chiefly the electric acoustic signal or signals most probably containing speech will then be fed out by the signal-processing means or post-processor module to a listening means or loudspeaker of the hearing aid, which listening means or loudspeaker will convert the electric acoustic signals into analog sound information.

A source separation method for acoustic signals, in particular a blind source separation method, is inventively expanded to include a feature-analysis means that determines the probability that speech is contained in the separated source signals. Proceeding from the probabilities determined of containing speech, the acoustic source or sources most probably containing speech will be selected and routed to the hearing-aid wearer. What is therein advantageous is automatable selecting of the acoustic-source signal or signals for which speech intelligibility is at a maximum. Interference signals containing no speech are preferably not focused. Speech signals (too) disrupted by interference signals will contain speech less probably than will undisrupted speech signals and so are likewise not be preferred. The method is based on the assumption that speech and the understanding thereof are most important for the hearing-aid wearer. The acoustic source is therein selected preferably independently of a direction of incidence relative to the hearing aid. It is, though, possible to use the direction of incidence or a volume of the respective acoustic source as a further selection criterion for the signal-processing means or the post-processor module.

Additional preferred exemplary embodiments of the invention will emerge from the other dependent claims.

### BRIEF DESCRIPTION OF THE DRAWINGS

The invention is explained in more detail below with the aid of exemplary embodiments and with reference to the attached drawing.

FIG. 1 is a block diagram of a hearing aid according to the prior art having a module for a blind source separation;

FIG. 2 is a block diagram of an inventive hearing aid having an inventive signal-processing means in the act of processing an ambient sound having two acoustically mutually independent acoustic sources; and

FIG. 3 is a block diagram of a second exemplary embodiment of the inventive hearing aid in the act of simultaneously processing three acoustically mutually independent acoustic sources in the ambient sound.

### DETAILED DESCRIPTION OF INVENTION

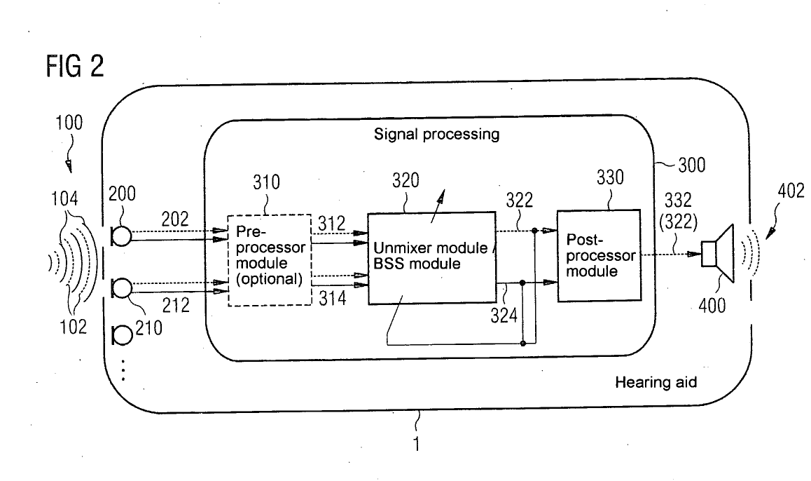

Within the scope of the invention (FIGS. 2 & 3), the following speaks mainly of a BSS module that corresponds to a module for a blind source separation. The invention is not, though, limited to a blind source separation of said type but is intended broadly to encompass source separation methods for acoustic signals in general. Said BSS module is therefore referred to also as an unmixer module.

The following speaks also of a “tracking” of an electric speech signal by a hearing-aid wearer's hearing aid. What is to be understood thereby is a selection made by a hearing aid or by a signal-processing means of the hearing aid or by a post-processor module of the signal-processing means of one or more electric speech signals that are electrically or electronically selected by the hearing aid from other acoustic sources in the ambient sound and which are rendered in a manner amplified with respect to the other acoustic sources in the ambient sound, which is to say in a manner experienced as louder for the hearing-aid wearer. Preferably no account is taken by the hearing aid of a position of the hearing-aid wearer in space, in particular a position of the hearing aid in space, which is to say a direction in which the hearing-aid wearer is looking, while the electric speech signal is being tracked.

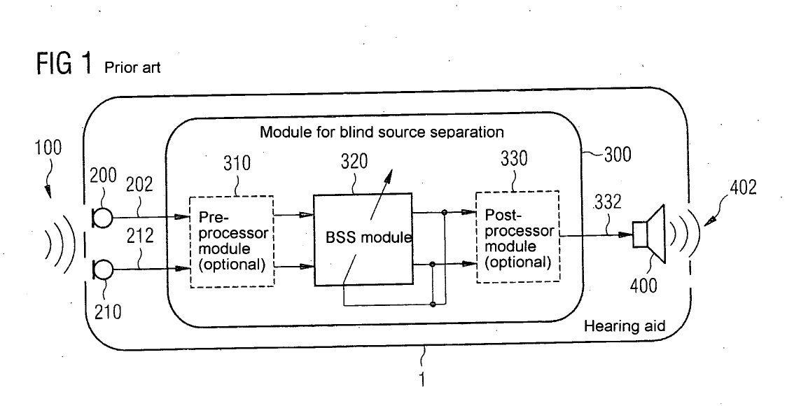

FIG. 1 shows the prior art as disclosed in EP 1 017 253 A2 (see therein paragraph [0008]ff). A hearing aid 1 therein has two microphones 200, 210, which can together form a directional microphone system, for generating two electric acoustic signals 202, 212. A microphone arrangement of said type gives the two electric output signals 202, 212 of the microphones 200, 210 an inherent directional characteristic. Each of the microphones 200, 210 picks up an ambient sound 100 which is an assemblage of unknown, acoustic signals from an unknown number of acoustic sources.

The electric acoustic signals 202, 212 are in the prior art mainly conditioned in three stages. The electric acoustic signals 202, 212 are in a first stage pre-processed in a pre-processor module 310 for improving the directional characteristic, starting with standardizing the original signals (equalizing the signal strength). A blind source separation takes place at a second stage in a BSS module 320, with the output signals of the pre-processor module 310 being subjected to an unmixing process. The output signals of the BSS module 320 are thereupon post-processed in a post-processor module 330 in order to generate a desired electric output signal 332 serving as an input signal for a listening means 400 or a loudspeaker 400 of the hearing aid 1 and to deliver a sound generated thereby to the hearing-aid wearer. According to the specification in EP 1 017 253 A2, steps 1 and 3, meaning the pre-processor module 310 and post-processor module 330, are optional.

FIG. 2 now shows a first exemplary embodiment of the invention wherein located in a signal-processing means 300 of the hearing aid 1 is an unmixer module 320, referred to below as a BSS module 320, connected downstream of which is a post-processor module 330. A pre-processor module 310 can herein again be provided that appropriately conditions or, as the case may be, prepares the input signals for the BSS module 320. Signal processing 300 preferably takes place in a DSP (Digital Signal Processor) or an ASIC (Application Specific Integrated Circuit).

It is assumed in the following that there are two mutually independent acoustic 102, 104 or, as the case may be, signal sources 102, 104 in the ambient sound 100, with one of said acoustic sources 102 being a speech source 102 and the other acoustic source 104 being a noise source 104. The acoustic speech source 102 is to be selected and tracked by the hearing aid 1 or signal-processing means 300 and is to be a main acoustic component of the listening means 400 so that an output sound 402 of the loudspeaker 400 mainly contains said signal (102).

The two microphones 200, 210 of the hearing aid 1 each pick up a mixture of the two acoustic signals 102, 104—indicated by the dotted arrow (representing the preferred, acoustic signal 102) and by the continuous arrow (representing the non-preferred, acoustic signal 104)—and deliver them either to the pre-processor module 310 or immediately to the BSS module 320 as electric input signals. The two microphones 200, 210 can be arranged in any manner. They can be located in a single hearing device 1 of the hearing aid 1 or be arranged on both hearing devices 1. It is moreover possible, for instance, to provide one or both microphones 200, 210 outside the hearing aid 1, for example on a collar or in a pin, so long as it is still possible to communicate with the hearing aid 1. That also means that the electric input signals of the BSS module 320 do not necessarily have to originate from a single hearing device 1 of the hearing aid 1. It is, of course, possible to implement more than two microphones 200, 210 for a hearing aid 1. A hearing aid 1 consisting of two hearing devices 1 preferably has a total of four or six microphones.

The pre-processor module 310 conditions the data for the BSS module 320 which, depending on its capability, for its part forms two separate output signals from its two, in each case mixed input signals, with each of said output signals representing one of the two acoustic signals 102, 104. The two separate output signals of the BSS module 320 are input signals for the post-processor module 330, in which it is then decided which of the two acoustic signals 102, 104 will be fed out to the loudspeaker 400 as an electric output signal 332.

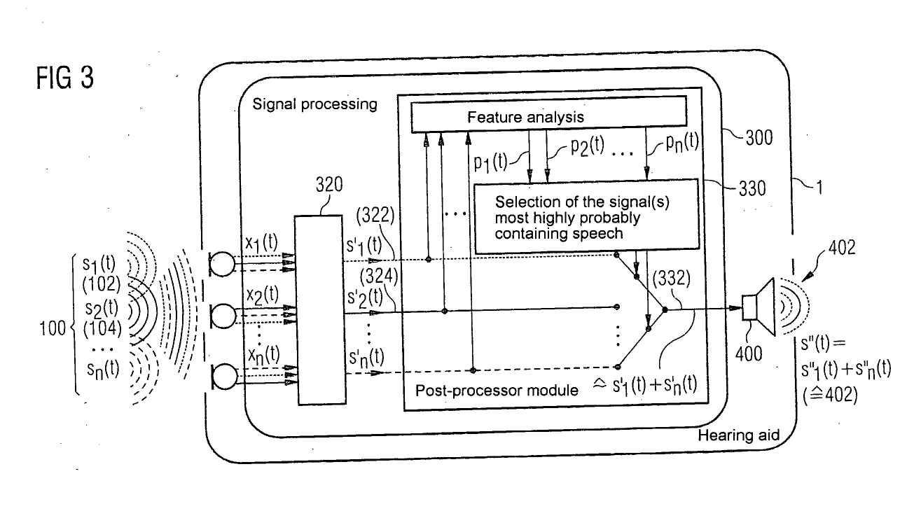

The post-processor module 330 for that purpose (see also FIG. 3) performs a feature analysis of the electric acoustic signals 322, 324 in parallel, with a probability being determined for each of said electric acoustic signals 322, 324 that it contains human speech. The post-processor module 330 then selects the acoustic signal 322 having the highest inherent probability of containing speech, and delivers said electric acoustic signal 322 in an amplified manner as an electric acoustic output signal 332 (corresponds basically to the electric acoustic signal 322) to the loudspeaker 400.

FIG. 3 shows the inventive method and the inventive hearing aid 1 in the act of processing three (n=3) acoustic signal sources s₁(t), s₂(t), sₙ(t) which, in combination, form the ambient sound 100. Said ambient sound 100 is picked up in each case by three microphones, which each feed out an electric microphone signal x₁(t), x₂(t), xₙ(t) to the signal-processing means 300. Although the signal-processing means 300 herein has no pre-processor module 310, it can preferably contain one. (That applies analogously also to the first exemplary embodiment of the invention). It is, of course, also possible to process n acoustic sources s simultaneously via n microphones x, which is indicated by the dots ( . . . ) in FIG. 3.

The electric microphone signals x₁(t), x₂(t), xₙ(t) are input signals for the BSS module 320, which separates the acoustic signals respectively contained in the electric microphone signals x₁(t), x₂(t), xₙ(t) according to acoustic sources s₁(t), s₂(t), sₙ(t) and feeds them out as electric output signals s′₁(t), s′₂(t), s′ₙ(t) to the post-processor module 330.

In the following, two electric acoustic signals, namely s′₁(t) and s′ₙ(t) (corresponding in this exemplary embodiment very largely to the acoustic sources s₁(t) and sₙ(t)), contain sufficient speech information. That means that the hearing aid 1 is rendered at least adequately capable of delivering an acoustic signal s′₁(t), s′ₙ(t) of said type to the hearing-aid wearer in such a way that he/she will be able to interpret the information contained therein adequately correctly, meaning will understand speech information contained therein at least adequately. It is further possible when a multiplicity of acoustic signals s′₁(t), s′ₙ(t) containing adequate speech information are present to select only those whose quality is the best or which the hearing-aid wearer prefers. The third acoustic signal s′₂(t) (corresponding in this exemplary embodiment very largely to the acoustic source s₂(t)) contains no or hardly any usable speech information.

A feature analysis of the electric acoustic signals s′₁(t), s′₂(t), s′ₙ(t) is then performed within the post-processor module 330 and a probability p₁(t), p₂(t), pₙ(t) determined separately for each electric acoustic signal s′₁(t), s′₂(t), s′ₙ(t) that it contains human speech information. The post-processor module 330 then selects the electric acoustic signal or, as in this case, the electric acoustic signals s′₁(t), s′ₙ(t) with the highest probabilities of containing speech, and makes them available to the loudspeaker 400 in the form of the output signal 332.

It is, of course, also possible in the case of the second exemplary embodiment of the invention to render only one or three or more acoustic speech sources s₁(t), sₙ(t) in an amplified manner.

The feature analysis in the post-processor module 330 can inventively always run concurrently in the background of the hearing aid 1 and be initiated when an electric speech signal 322; s′₁(t), s′ₙ(t) arises. It is also possible for the inventive feature analysis to be called up by the hearing-aid wearer. That means that the “speech” operating mode of the hearing aid 1 will be established initiated from an input device that can be called up or actuated by the hearing-aid wearer. The input device can therein be a control element on the hearing aid 1 and/or a control element on a remote control of the hearing aid 1, for example a pushbutton or switch (not shown in the Figs.). It is possible, moreover, for the input device to be embodied as a voice-control means having an assigned speaker-recognition module attuned to a voice of the hearing-aid wearer, with the input device being embodied at least partially in the hearing aid 1 and/or at least partially in the remote control of the hearing aid 1.

It is furthermore possible to by means of the hearing aid 1 obtain additional information about which of the electric speech signals 322; s′₁(t), s′ₙ(t) are preferably rendered to the hearing-aid wearer as output sound 402, s″(t). That can be an angle at which the corresponding acoustic source 102, 104; s₁(t), s₂(t), sₙ(t) impinges on the hearing aid 1, with certain such angles being preferred. Thus, for example, the 0° direction in which the hearing-aid wearer is looking or his/her 90° lateral direction can be preferred. The electric speech signals 322; s′₁(t), s′ₙ(t) can furthermore be weighted to the effect—even apart from the different probabilities p₁(t), p₂(t), pₙ(t) that they contain speech information (that of course applies to all exemplary embodiments of the invention)—as to whether one of the electric speech signals 322; s′₁(t), s′ₙ(t) is predominant or a relatively loud electric speech signal 322; s′₁(t), s′ₙ(t).

It is inventively not necessary to perform the feature analysis of the electric acoustic signals 322; 324; s′₁(t), s′₂(t), s′ₙ(t) within the post-processor module 330. It is also possible, for example for reasons of speed, to have the feature analysis performed by another module of the hearing aid 1 and to leave just selecting of the electric acoustic signal or signals 322, 324; s′₁(t), s′₂(t), s′ₙ(t) having the highest probability or probabilities p₁(t), p₂(t), pₙ(t) of containing speech to the post-processor module 330. With that kind of exemplary embodiment of the invention, said other module of the hearing aid 1 ought, by definition, to be included in the post-processor module 330, meaning in that kind of exemplary embodiment the post-processor module 330 will encompass said other module.

The present specification relates inter alia to a post-processor module 20 as in EP 1 017 253 A2 (the reference numerals are those given in EP 1 017 253 A2), in which module one or more speakers for an electric output signal of the post-processor module 20 is/are selected by means of a feature analysis and rendered therein at least amplified. See in that regard also paragraph [0025] in EP 1 017 253 A2. The pre-processor module and the BSS module can in the inventive case furthermore be structured like the pre-processor 16 and the unmixer 18 in EP 1 017 253 A2. See in that regard in particular paragraphs [0008] to [0024] in EP 1 017 253 A2.

The invention furthermore links to EP 1 655 998 A2 in order to make stereo speech signals available or, as the case may be, enable a binaural acoustic provisioning with speech for a hearing-aid wearer. The invention (notation according to EP 1 655 998 A2) is herein connected downstream of the output signals z1, z2 respectively for the right(k) and left(k) of a second filter device in EP 1 655 998 A2 (see FIGS. 2 and 3) for accentuating/amplifying the corresponding acoustic source. It is furthermore possible to apply the invention in the case of EP 1 655 998 A2 to the effect that it will come into play after the blind source separation disclosed therein and ahead of the second filter device. That means that a selection of a signal y1(k), y2(k) will therein inventively take place (see FIG. 3 in EP 1 655 998 A2).

1.-26. (canceled)

27. A method for operating a hearing aid, comprising:
establishing a speech operating mode is established by a signal-processor of the hearing aid for tracking and selecting an acoustic speech source in an ambient sound;
generating electric acoustic signals by the hearing aid from the ambient sound;
identifying from the generated signals an electric speech signal having a high probability of containing speech, the identification by the signal-processor; and
outputting the electric speech signal to be acoustically prominent compared with another acoustic source and thereby be better perceived by a hearing-aid wearer.

28. The method as claimed in claim 27, further comprises separately tracking a plurality of acoustically mutually independent acoustic speaker sources via the signal processor.

29. The method as claimed in claim 27,
further comprises performing a feature analysis of the generated by the signal-processor, in order to determine a probability that the respective generated signal contains speech information, and
wherein the generated signal containing no speech or disrupted by interference signals over a threshold are not considered by the signal-processor for identification.

30. The method as claimed in claim 27, wherein the signal-processor includes an unmixer module for separating the generating electric acoustic signals and a post-processor module for establishing the “speech” operating mode of the hearing aid.

31. The method as claimed in claim 30, wherein a volume of the signals generated by the unimixer module is adjusted in the post-processor module for the output of the electric acoustic output signal.

32. The method as claimed in claim 27, wherein the acoustic speech source is identified from the generated signals at least by one criterion selected from the group consisting of volume, frequency range, respective frequency extremes, and freedom from interference.
